(19) United States
(12) Patent Application Publication
(10) Pub. No.: US 2015/0269234 A1
(43) Pub. Date: Sep. 24, 2015

(54) User Defined Functions Including Requests for Analytics by External Analytic Engines

(71) Applicant: HEWLETT-PACKARD DEVELOPMENT COMPANY, L.P., Houston, TX (US)

(72) Inventors: Maria G Castellanos, Palo Alto, CA (US); Meichun Hsu, Palo Alto, CA (US); Qiming Chen, Palo Alto, CA (US)

(73) Assignee: HEWLETT-PACKARD DEVELOPMENT COMPANY, L.P., Houston, TX (US)

(21) Appl. No.: 14/219,209

(22) Filed: Mar. 19, 2014

(51) Int. Cl. G06F 17/30

(52) U.S. Cl. CPC G06F 17/30563

(57) ABSTRACT

Described herein are techniques enabling a query engine to process a query comprising a user defined function. The user defined function can include a request for analytics to be performed by an external analytic engine. The query engine can retrieve data from a database in accordance with the query and send the data and instructions to perform the analytics to the external analytic engine. The query engine can then receive analytic results from the external analytic engine.

### BACKGROUND

Enterprises (e.g. business concerns, educational organizations, government agencies) can depend on reports and analyses of data. To generate the reports and analyses, workloads, such as queries, can be executed in an execution environment. For example, an analytic engine, such as a query engine, can execute a query over a database and generate a report.

There are various analytic engines available, each of which can provide different functionalities, capabilities, and the like. Example engines include HP Vertica, Autonomy Idol, and HP ArcSight. The various engines can also vary in their ease of use. It can be difficult for a user to master multiple engines. It can be even more difficult for a user to take advantage of the functionalities of multiple engines to generate a single report or analysis of data.

### BRIEF DESCRIPTION OF DRAWINGS

The following detailed description refers to the drawings, wherein:

FIG. 1 illustrates a method of processing a query that includes a user defined function representing a request for analytics by an external engine, according to an example.

FIG. 2 illustrates a method of processing a user defined function portion of a query representing a request for analytics by an external engine, according to an example.

FIG. 3 illustrates a system for processing a query that includes a user defined function representing a request for analytics by an external engine, according to an example.

FIG. 4 illustrates a computer-readable medium for processing a query that includes a user defined function representing a request for analytics by an external engine, according to an example.

### DETAILED DESCRIPTION

Workloads, such as queries, may be executed in an execution environment. For example, a query engine (e.g., HP Vertica) can execute a query over a database to generate analytic results on data stored in the database. These results can be provided to a user in a report.

The user can write the query via a user interface and submit the query to the query engine. However, the user may desire that certain analytics be performed that are not supported by the query engine. For example, the user may desire analytics that require execution on two or more different analytic engines, such as both HP Vertica and Autonomy Idol. This can be challenging because the analytic engines may require instruction in different programming languages, the engines may not be easily compatible, the user may not have expertise with each of the engines, etc. Moreover, many queries are complex analytic tasks that require significant coordination in executing a query plan. Much of this coordination is handled by the query engine on the backend as it executes a query. By introducing a second analytic engine, however, the user may be responsible for ensuring such coordination. Coordinating intermediate analytic results between multiple engines to yield a single result can be extremely difficult and can require a level of database and engine knowledge, programming skills, and attention to detail that many users do not have.

According to the techniques described herein, joint execution of a workload on different engines (e.g., HP Vertica, Autonomy Idol, HP ArcSight) is enabled. This joint execution can be provided via a single engine in a way that is largely transparent to the user. This can be useful when an analytic task requires functionalities that belong to different engines. For instance, being able to formulate Structured Query Language (SQL) queries in HP Vertica, where part of the execution is done in HP Vertica and another part in Autonomy Idol (which doesn't understand SQL), can enable the user to write powerful queries and applications that take advantage of the functionalities/capabilities of both engines. Thus, the techniques disclosed herein make functionalities of a second engine readily-available for a user rather than requiring the user to explicitly deal with the second engine. This can be especially advantageous where a second engine is especially complex and hard to use and/or where only a limited set of functionality of the second engine is required (thus not justifying the time and expense of mastering the second engine).

According to an example, a query including a user defined function (UDF) can be received by a query engine. The UDF can include a request for analytics by an external engine (that is, an engine external to the query engine). The query engine can execute the query until processing is required on the UDF. The query engine may then execute the UDF in conjunction with the external engine. For example, a UDF module in the query engine can interpret the UDF and generate instructions and transform data for the external engine. The UDF module can run as a process separate from the main process running on the query engine. The instructions and data can be sent to the external engine for processing. The query engine can subsequently receive analytic results from the external engine. These analytic results can be transformed into a correct format for further processing by the query engine. The query engine can execute the rest of the query and return final analytic results to the user. As a result, the user is able to leverage the capabilities of two analytic engines while having to deal with the language and intricacies of only one engine, as well as avoiding the complexity associated with coordinating execution of a workload on multiple engines. Additional examples, advantages, features, modifications and the like are described below with reference to the drawings.

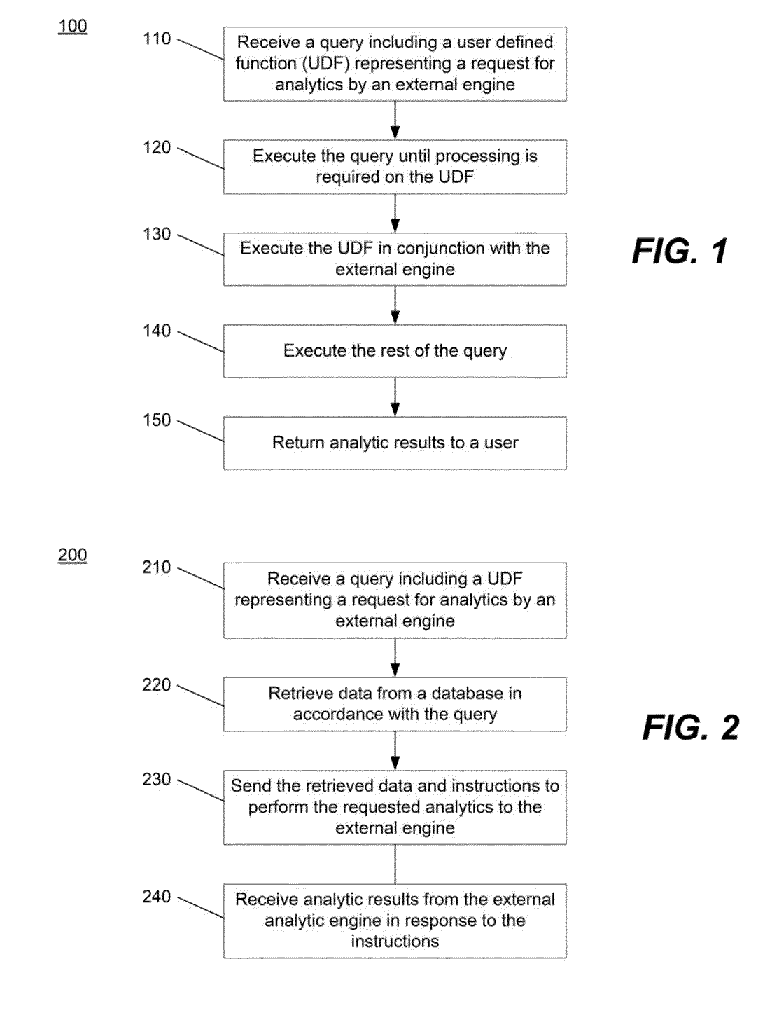

FIG. 1 illustrates a method for processing a query that includes a user defined function representing a request for analytics by an external engine, according to an example. Method 100 may be performed by a computing device, system, or computer, such as query engine 330 or computer 410. Computer-readable instructions for implementing method 100 may be stored on a computer readable storage medium. These instructions as stored on the medium are referred to herein as “modules” and may be executed by a computer.

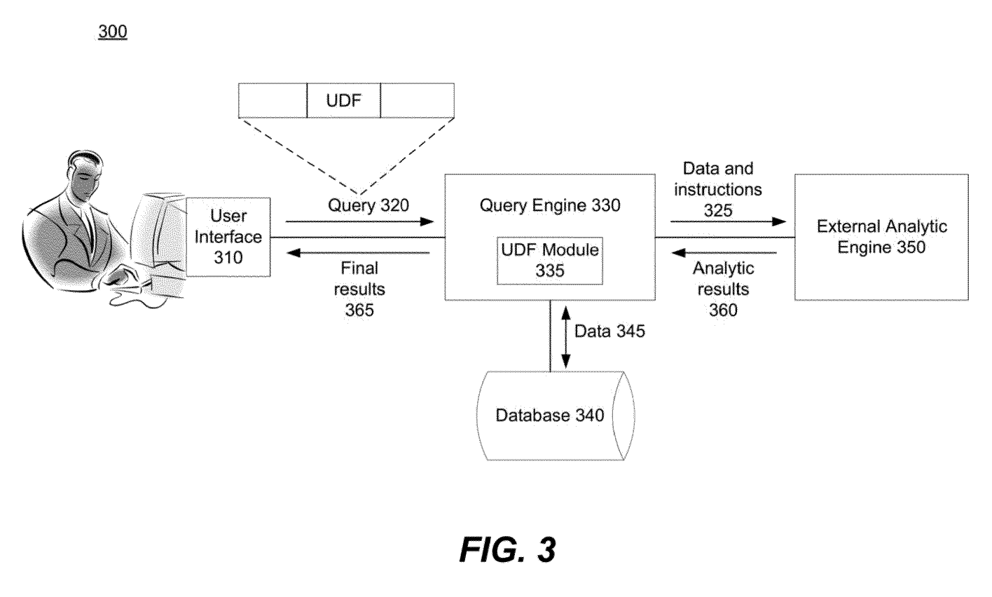

Methods 100 and 200 will be described here relative to environment 300 of FIG. 3. Environment 300 may include and/or be implemented by one or more computers. For example, the computers may be server computers, workstation computers, desktop computers, laptops, mobile devices, or the like, and may be part of a distributed system. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, system 300 may include one or more machine-readable storage media separate from the one or more controllers.

Environment 300 may include a number of components. For example, environment 300 may include a user interface 310, a query engine 330, a database 340, and an external analytic engine 350. Environment 300 may be interconnected via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing. Multiple computers implementing the various components of environment 300 may also be connected to each other via a network.

Method 100 may begin at 110, where a query 320 may be received by query engine 330. Query engine 330 can include one or multiple execution stages for applying respective operators on data, where the operators can transform or perform some other action with respect to data. Query engine 330 can be associated with database 340. A database refers to one or multiple collections of data. For example, an enterprise may have multiple database storing data generated in the course of business.

Together, query engine 330 and database 340 can constitute an execution environment. An execution environment can be available in a public cloud or public network, in which case the execution environment can be referred to as a public cloud execution environment. Alternatively, an execution environment that is available in a private network can be referred to as a private execution environment.

As an example, query engine 330 and database 340 may constitute a database management system (DBMS). A DBMS stores data in relational tables in a database and applies database operators (e.g. join operators, update operators, merge operators, and so forth) on data in the relational tables. An example DBMS environment is HP Vertica.

The DBMS may execute a workload. A workload may include one or more operations to be performed in the execution environment. For example, the workload may be a query, such as a Structured Query Language (SQL) query. The workload may be some other type of workflow, such as a Map-Reduce workflow to be executed in a Map-Reduce execution environment or an Extract-Transform-Load (ETL) workflow to be executed in an ETL execution environment. Other analytic engines include Autonomy Idol and HP ArcSight.

In order for a given execution environment or analytic engine to perform a workload, the workload should be specified in a language understood by the analytic engine. Thus, for example, a workload submitted to HP Vertica should be written in SQL. However, an SQL workload would generally not be executable on Autonomy Idol or in a Map-Reduce execution environment.

Query 320 can be created by a user via user interface 310. User interface 310 can be associated with query engine 330 and can be configured to enable writing queries in a format understandable by query engine 330. Thus, if query engine 330 is HP Vertica, the user interface can enable the creation of queries in SQL. For ease of explanation, the remainder of the description will assume that query engine 330 is HP Vertica.

Because query engine 330 is HP Vertica, query 320 is written in SQL. Part of query 320 may be directed to functionality provided by HP Vertica. Thus, query 320 may specify that data be retrieved from database 340 and may specify various operations to be performed on that data by HP Vertica, such as joins, merges, selections, sorts, etc. Query 320 may also include a portion directed to functionality provided by external analytic engine 350. External analytic engine 350 may be an engine external to HP Vertica that provides additional functionality not provided by HP Vertica. For example, external analytic engine 350 may be Autonomy Idol. Some examples of analytic operations supported by Autonomy Idol are text analysis, clustering, and classification. However, since Autonomy Idol does not understand workloads written in SQL, the portion of query 320 directed to Idol may be implemented via a user defined function (UDF in query 320). The UDF may thus represent a request for analytics by external analytic engine 350.

In HP Vertica, a UDF is generally used to perform data manipulations that are too complex or too slow to perform using SQL statements and functions. A UDF can be generated by writing classes in a programming language other than SQL. The classes can be stored in a shared library accessible by HP Vertica. As examples, the classes can be written in C++, Java, or the statistical programming language R. When a UDF is referenced in a query, HP Vertica can then access the appropriate classes in the shared library and execute the operations specified by the UDF. The UDF can be executed by the same main process implementing the query engine (referred to as operating in “unfenced mode”) or it can be executed by a separate process (referred to as operating in “fenced mode”). For instance, if the UDF is written in C++, the UDF can be implemented by the main process or by a separate process. If the UDF is written in Java, however, the UDF is implemented by a separate process because the Java program is executed by a Java Virtual Machine, which executes outside of the main process. Other analytic engines also support UDFs, though the implementation details may differ from HP Vertica.

By using the techniques disclosed here, a UDF is used as a vehicle for requesting and coordinating the execution of analytic operations by another analytic engine external to HP Vertica. This is done largely transparently to the user, as the user does not interface with the external analytic engine. Rather, the user can merely specify a pre-existing UDF (i.e., one stored in the shared library) in query 320, providing the appropriate data and parameters, and HP Vertica executes the UDF and coordinates with the external analytic engine on the backend, transparently to the user. This will be described in more detail relative to FIG. 2 after FIG. 1 is fully described.

At 120, query 320 is executed by query engine 330 until processing is required on the UDF. Thus, for example, query engine 330 executes the various operations specified by query 320 before the UDF is reached. Such operations can include retrieving data 345 from database 340 and manipulating the data using functional operations specified by the query and supported by the query engine.

At 130, the UDF portion of query 320 is executed by query engine 330 in conjunction with the external analytic engine. The UDF portion can be executed by UDF module 335, either by the main process of query engine 330 or by a separate process, as described above. As will be described in FIG. 2, execution of the UDF portion by query engine 330 can include retrieving appropriate data from database 340, manipulating that data through parsing, sorting, or the like, converting the data into a format understandable by external analytic engine 350, generating instructions specified in the language of the external analytic engine 350 for performing one or more operations specified by the UDF, and sending the data and instructions 325 to external analytic engine 350. UDF module 335 can then receive analytic results 360 from external analytic engine 350 and convert the analytic results 360 into a format usable by query engine 330.

At 140, any remaining portion of query 320 may be executed by query engine 330. The analytic results 360 received from external analytic engine 350 may be used in executing the remaining portion of the query. For example, the query engine 330 could correlate the analytic results 360 with data from database 340. In particular, where query engine 330 is HP Vertica and external analytic engine 350 is Autonomy Idol, the analytic results 360 may relate to unstructured data (e.g., text) and the data from the database may be structured data. Thus, the analytic results of unstructured data may be combined with structured data for additional insight that may not have been available using just query engine 350.

For instance, if the analytics performed by external analytic engine 350 include sentiment analysis of text-based customer reviews and reports (unstructured data), and the analytic results 360 are the sentiment scores, the query engine 330 could join the sentiment scores with corresponding customer information (structured data) stored in database 340. This could be helpful, for example, for enabling a company providing services or products to customers to identify those customers who spend at least a certain amount of money on a regular basis (e.g., more than $100K per month) and that are prone to change to another provider given the negative sentiment expressed in the customer reviews and reports. By correlating this information and identifying those customers at risk of changing providers, the company could take actions to repair the relationship with those customers so that they remain customers.

Of course, query 320 may include other operations (e.g., other than JOIN) that query engine 330 could perform after receiving the analytic results 360. For instance, the other operations could include any operations supported by the query engine, such as group by aggregations, selections, etc. Additionally, the remaining portion of query 320 may include invocations of other UDFs to be executed in conjunction with external analytic engine 350.

At 150, final analytic results 365 may be returned to the user, such as via user interface 310. As a result, the user has been able to leverage the capabilities of two analytic engines while having to deal with the language and intricacies of only one engine (query engine 330—HP Vertica), as well as avoiding the complexity associated with coordinating execution of a workload on multiple engines.

FIG. 2 illustrates a method of processing a user defined function portion of a query representing a request for analytics by an external engine, according to an example. Method 200 begins at 210, where a query including a UDF representing a request for analytics by an external engine is received. In some examples, the query can include multiple UDFs. The UDF may include input parameters and may specify the data to be operated on by the external engine. As described earlier, the UDF is implemented by classes stored in a shared library. These classes can define a workflow to be executed by the query engine 330 in conjunction with the external analytic engine 350.

The workflow may include operations to be performed by the query engine 330, such as retrieving data, manipulating the data, converting the data into a format usable by the external analytic engine, generating instructions for the external analytic engine to perform one or more analytic operations on the data (the analytic operations being native functions of the external analytic engine), and processing the analytic results received back from the external analytic engine. The workflow can further include instructions and parameters for connecting to the external analytic engine (such as via a communication interface of query engine 330 and an application programming interface of external analytic engine 350).

Below are definitions of two example UDFs entitled “search_tala” and “cluster_tala” that are supported by query engine 330. In this example, the UDFs are supported by HP Vertica (query engine 330) and are used to request analytics from Autonomy Idol (external analytic engine 350). The definitions may be available to the user in a user guide for query engine 330. The definitions describe what the UDFs are used for, describe the inputs and outputs, specify the parameters associated with the UDFs (in some examples, values for these parameters may be stored as defaults, may be overridden by a user, or may be supplied by the user), and provide some example SQL statements invoking the UDFs. Note that the example SQL statements provided in the definition for “cluster_tala” UDF invoke both the “search_tala” UDF and the “cluster_tala” UDF. In particular, in each example the “search_tala” UDF is invoked and the results are then input to the “cluster_tala” UDF. These are just two example UDFs, and of course many others may be created and supported by query engine 330.

search_tala UDF
search_tala allows to submit a query to IDOL server.

### Inputs:

Text: Query text or user can use a table column as input.

### Outputs:

Search results: document reference, database, score

### Parameters:

| Parameter | Description | Default | Note |
|---|---|---|---|
| host | IDOL Server | idol1.hpl.hp.com | |
| port | IDOL ACI port | 9100 | |
| db | Database | | User can |
| | | | define |
| | | | multiple |
| | | | databases |
| | | | separate by |
| | | | a space. |
| state | The state token | | |
| | of a group | | |
| | of documents | | |
| | to return | | |
| field | Field restriction | content | |
| | to the query | | |
| type | Type of search | conceptual | conceptual, |
| | | | boolean, |
| | | | keyword. |
| minScore | Minimum score | 40 | |
| | that results | | |
| | must have. | | |
| maxResults | Maximum number | 10000 | |
| | of to show. | | |
| storeState | Whether to | true | If flag is |
| | store results | | true shows |
| | in a state token. | | a state, |
| | | | else shows |
| | | | reference, |
| | | | database |
| | | | and score. |

### Examples:

SELECT search_tala(‘hewlett packard’) OVER( );

SELECT name, search_tala(name) OVER(PARTITION BY name) FROM company;

SELECT search_tala(‘hewlett packard’ USING PARAMETERS storeState=false, maxResults=5) OVER( );

SELECT search_tala(‘autonomy’ USING PARAMETERS state=‘P0AL0EG462V8-5000’) OVER( );

cluster_tala UDF
cluster_tala allows to analyze dusters generated by IDOL. The sql statement returns cluster name, number of documents, score and the reference of the documents in the duster.

### Inputs:

cluster_tala receives as input a state (or list of states) or a list of document references with their databases.

### Outputs:

Documents assignments to clusters: document reference, database, cluster id, score

### Parameters:

| Parameter | Description | Default | Note |
|---|---|---|---|
| host | IDOL Server | idol1.hpf.hp.com | |
| port | IDOL ACI port | 9100 | |
| maxResults | The maximum number | 10000 | |
| | of documents to list for | | |
| | each cluster. | | |
| maxTerms | The maximum number | 3 | |
| | of terms to return. | | |

### Examples:

SELECT cluster_tala(s.storeState) OVER( ) FROM (SELECT search_tala(‘hp’) OVER( )) AS s;

SELECT cluster_tala(s.Reference, s.DB) OVER( ) FROM (SELECT search_tala(‘hp’ USING PARAMETERS storeState=false) OVER( )) AS s;

At 220, data 345 can be retrieved from database 340 in accordance with the query 320. At 230, the retrieved data and instructions to perform the requested analytics 325 can be sent to the external analytic engine 350. At 240, analytic results 360 can be received from the external analytic engine 350.

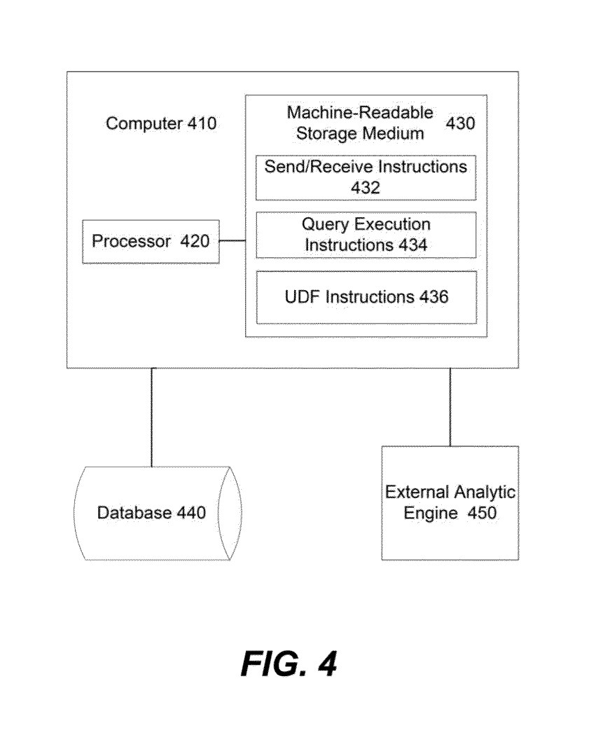

FIG. 4 illustrates a computer-readable medium for processing a query that includes a user defined function representing a request for analytics by an external engine, according to an example. Computer 410 may include and/or be implemented by one or more computers. For example, the computers may be server computers, workstation computers, desktop computers, laptops, mobile devices, or the like, and may be part of a distributed system. The computers may include one or more controllers and one or more machine-readable storage media, as described with respect to environment 300, for example.

In addition, users of computer 410 may interact with computer 410 through one or more other computers, which may or may not be considered part of computer 410. As an example, a user may interact with computer 410 via a computer application residing on a computer, such as a desktop computer, workstation computer, tablet computer, or the like. The computer application can include a user interface (e.g., touch interface, mouse, keyboard, gesture input device).

Computer 410 may perform methods 100 and 200, and variations thereof. Additionally, the functionality implemented by computer 410 may be part of a larger software platform, system, application, or the like. For example, computer 410 may be part of a data analysis system.

Computer(s) 410 may implement a query engine and may have access to a database 440. The database may include one or more computers, and may include one or more controllers and machine-readable storage mediums, as described herein. Computer 410 may also be connected to an external analytic engine 450. Computer 410 may be connected to the database 440 and external analytic engine 450 via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

Processor 420 may be at least one central processing unit (CPU), at least one semiconductor-based microprocessor, other hardware devices or processing elements suitable to retrieve and execute instructions stored in machine-readable storage medium 430, or combinations thereof. Processor 420 can include single or multiple cores on a chip, multiple cores across multiple chips, multiple cores across multiple devices, or combinations thereof. Processor 420 may fetch, decode, and execute instructions 432-436 among others, to implement various processing. As an alternative or in addition to retrieving and executing instructions, processor 420 may include at least one integrated circuit (IC), other control logic, other electronic circuits, or combinations thereof that include a number of electronic components for performing the functionality of instructions 432-436. Accordingly, processor 420 may be implemented across multiple processing units and instructions 432-436 may be implemented by different processing units in different areas of computer 410.

Machine-readable storage medium 430 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 430 can be computer-readable and non-transitory. Machine-readable storage medium 430 may be encoded with a series of executable instructions for managing processing elements.

The instructions 432-436 when executed by processor 420 (e.g., via one processing element or multiple processing elements of the processor) can cause processor 420 to perform processes, for example, methods 100 and 200, and/or variations and portions thereof.

For example, send/receive instructions 432 may cause processor 420 to receive a query comprising a user defined function (UDF). The UDF may include a request for analytics by an external analytic engine. Query execution instructions 434 may cause processor 420 to access data from database 440 in accordance with the query. UDF instructions 434 may cause processor 420 to process the UDF, including generating instructions to perform the requested analytics in a format understandable by the external analytic engine 450. Send/receive instructions 432 may cause processor 420 to send the data and instructions to the external analytic engine and receive analytic results from the external analytic engine in response to the instructions.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method comprising, by a query engine associated with a database:
receiving a query comprising a user defined function portion, the user defined function portion comprising a request for analytics by an external analytic engine;
retrieving data from the database in accordance with the query;
sending the retrieved data and instructions to perform the requested analytics on the retrieved data to the external analytic engine; and
receiving analytic results from the external analytic engine in response to the instructions.

2. The method of claim 1, wherein the user defined function portion specifies the data to be retrieved from the database and comprises parameters identifying the external analytic engine.

3. The method of claim 1, wherein the query comprises an additional portion comprising additional operations to be performed by the query engine, the method further comprising:
executing the additional portion by performing the additional operations on the analytic results received from the external analytic engine.

4. The method of claim 3, wherein the additional operations comprise joining the analytic results received from the external analytic engine with data from the database.

5. The method of claim 1, wherein the retrieved data and instructions are sent to the external analytic engine via a user defined function module of the query engine.

6. The method of claim 1, wherein the retrieved data is converted into a format required by the external analytic engine.

7. A system comprising:
a database;
a query engine to execute a query comprising a user defined function defining an analytic operation to be performed by an external analytic engine; and
a communication interface;
the query engine to execute the query over the database by (1) retrieving data from the database according to the query and (2) sending the data and instructions to perform the analytic operation to the external analytic engine via the communication interface,
the communication interface to receive analytic results from the external analytic engine.

8. The system of claim 7, wherein the database is a relational database, the query is written in Structured Query Language (SQL), and the instructions to the external analytic engine are written in a language other than SQL.

9. The system of claim 8, further comprising a user interface to receive query input from a user in SQL.

10. The system of claim 9, wherein the user defined function is executed transparently to the user in that the user does not interface with the external analytic engine.

11. The system of claim 7, wherein the query engine is configured to package the data and instructions in a format understandable by the external analytic engine.

12. The system of claim 7, wherein the query engine is configured to transform the analytic results received from the external analytic engine into a format understandable by the query engine.

13. The system of claim 7, wherein the analytic operation defined by the user defined function is implemented at least in part by at least one native function of the external analytic engine.

14. The system of claim 7, wherein the analytic operation defined by the user defined function is implemented at least in part by a workflow including at least one native function of the external analytic engine and additional functional logic not native to the external analytic engine.

15. The system of claim 14, the query engine comprising a UDF module to process the user defined function,
the instructions to perform the analytic operation comprising instructions to perform the at least one native function of the external analytic engine,
the UDF module to send the data and instructions to perform the analytic operation to the external analytic engine via the communication interface, and
the UDF module to execute the additional functional logic not native to the external analytic engine.

16. A non-transitory computer-readable storage medium storing instructions for execution by a query engine associated with a database, the instructions when executed causing the query engine to:
receive a query comprising a user defined function, the user defined function comprising a request for analytics by an external analytic engine;
access data from the database in accordance with the query;
generate instructions to perform the requested analytics in a format understandable by the external analytic engine;
send the data and instructions to the external analytic engine; and
receive analytic results from the external analytic engine in response to the instructions.
